(19) United States
(12) Patent Application Publication
(10) Pub. No.: US 2015/0005159 A1
(43) Pub. Date: Jan. 1, 2015

(54) Optimization of Zero-PGM Metal Loading on Metallic Substrates

(71) Applicants: Zahra Nazarpoor, Camarillo, CA (US); Sen Kitazumi, Oxnard, CA (US); Johnny T. Ngo, Oxnard, CA (US)

(72) Inventors: Zahra Nazarpoor, Camarillo, CA (US); Sen Kitazumi, Oxnard, CA (US); Johnny T. Ngo, Oxnard, CA (US)

(73) Assignee: CDTi, Ventura, CA (US)

(21) Appl. No.: 13/927,953

(22) Filed: Jun. 26, 2013

(51) Int. Cl. B01J 23/89; B01J 23/83

(52) U.S. Cl. CPC B01J 23/8926; B01J 23/83
USPC 502/304; 502/345

(57) ABSTRACT

The present disclosure refers to a plurality of process employed for optimization of Zero-PGM metal loading in Washcoat and Overcoat on metallic substrates. According to an embodiment a substantial increase in conversion of HC and CO may be achieved by optimizing the metal loading of the catalyst. According to another embodiment, the present disclosure may provide solutions to determine the optimum metal loading in washcoat for minimizing washcoat adhesion loss. As a result, may increase the conversion of HC and CO from discharge of exhaust gases from internal combustion engines, optimizing performance of Zero-PGM catalyst systems.

### CROSS-REFERENCE TO RELATED APPLICATIONS

N/A

### BACKGROUND

1. Field of the Disclosure

The present disclosure relates generally to ZPGM catalytic systems, and more particularly to optimize the total metal loading of Zero-PGM on metallic substrates.

2. Background Information

One of the major problems with manufacturing catalyst systems may be achieving the proper metal loading for adhesion of a washcoat to a substrate and/or adhesion of a washcoat to an overcoat. A plurality of factors may affect the adhesion of a washcoat to a substrate and/or of an overcoat to a washcoat, which may include, but are not limited to employing a suitable substrate dimension and cell density, washcoat and overcoat particle size, suitable formulation, optimized loading of ZPGM metals and optimized loading of washcoat and overcoat.

Accordingly may be highly desirable to have optimized ZPGM metal loading in washcoat and overcoat, which may produce improvements for controlling exhaust emissions achieving similar or better efficiency than existing oxidation catalysts systems.

### SUMMARY

The present disclosure may provide solutions for optimization of Zero-PGM metal loading on metallic substrates for consistently producing a uniform thickness and well adhered coating, increasing HC and CO conversion, therefore enhancing performance of catalyst systems.

According to an embodiment of the present disclosure may employ a catalyst system completely free of PGM for low temperature conversion. ZPGM catalysts may be in the form of aqueous slurry, as a coating may be deposited on suitable metallic substrates in order to fabricate ZPGM catalyst systems, which may be employed within catalytic converters, to convert toxic exhaust gases such as CO to less harmful carbon dioxide, and oxidizing un-burned HC to carbon dioxide and water.

In the present disclosure, ZPGM catalyst system may include at least three layers of materials: a metallic substrate, a washcoat, and an overcoat. According to embodiments in the present disclosure, the formulation for optimized washcoats may generally include at least one Zero-PGM transition metal catalyst, such as silver, and carrier material oxides, such as Al₂O₃. Optimized overcoats generally include a completely free of platinum group metal catalysts such as copper, rare earth metals such as cerium, and carrier material oxides, but also oxygen storage materials (OSM's). Alternative embodiments may include CeO₂, ZrO₂, and TiO₂, among others, as carrier material oxides. Washcoat or overcoat materials and Zero-PGM catalysts may be deposited on a substrate in a single step, employing a co-milling process, or may be synthesized by a suitable chemical technique, such as co-precipitation or any other suitable technique known in the art.

According to an embodiment, the present disclosure may provide solutions to minimize washcoat adhesion loss and maximize HC and CO conversion by optimizing metal loading.

By increasing the copper loading, the washcoat adhesion loss may significantly increase, without having so much dependency on silver loading.

According to another embodiment, the cerium—copper ratio is constant, therefore when copper loading changed, the cerium may be calculated based on cerium-copper weight ratio.

A substantial increase in conversion of HC and CO may be achieved by optimizing the ratio between metal loadings. According to another embodiment, in order to optimize conversion of HC and CO, and to be able to keep washcoat adhesion loss minimized, may require keeping copper loading below 8 g/L.

The present disclosure may provide solutions to increase HC and CO conversion from discharge of exhaust gases from internal combustion engines, by having good correlation between metal loadings and HC and CO conversions.

These and other advantages of the present disclosures may be evident to those skilled in the art, or may become evident upon reading the detailed description of related embodiments, as shown in accompanying drawings.

### BRIEF DESCRIPTION OF THE DRAWINGS

The present disclosure can be better understood by referring to the following figures. The components in the figures are not necessarily to scale, emphasis instead being placed upon illustrating the principles of the disclosure. In the figures, reference numerals designate corresponding parts throughout the different views.

FIG. 1 shows HC light-off test results for HC conversion of fresh and aged samples, according to one embodiment.

FIG. 2 shows CO light-off test results for CO conversion of fresh and aged samples, according to one embodiment.

FIG. 3 shows correlation between ZPGM metal loadings and washcoat adhesion loss, according to one embodiment.

FIG. 4 shows silver loading in washcoat for optimum point range based on prediction model, according to one embodiment.

FIG. 5 shows copper loading in overcoat for optimum point range based on prediction model, according to one embodiment.

The present disclosure hereby described in detail with reference to embodiments illustrated in drawings, which form a part hereof. Other embodiments may be used and/or and other changes may be made without departing from the spirit or scope of the present disclosure. The illustrative examples described in detailed description are not meant to be limiting the subject matter presented herein.

### Definitions

All scientific and technical terms used in the present disclosure may have meanings commonly used in the art, unless otherwise specified. The definitions provided herein, are to facilitate understanding of certain terms used frequently and are not meant to limit the scope of present disclosure.

As used herein, the following terms may have the following definitions:

“Catalyst system” refers to a system of at least three layers, which may include at least one substrate, a washcoat, and an optional overcoat.

“Substrate” refers to any suitable material for supporting a catalyst and can be of any shape or configuration, which yields sufficient surface area for deposition of washcoat.

“Washcoat” refers to at least one coating including at least one oxide solid which may be deposited on a substrate.

“Overcoat” refers to at least one coating including one or more oxide solid which may be deposited on at least one washcoat.

“Oxide solid” refers to any mixture of materials selected from the group including a carrier material oxide, a catalyst, and a mixture thereof.

“Carrier material oxide” refers to materials used for providing a surface for at least one catalyst.

“Oxygen storage material” refers to materials that can take up oxygen from oxygen-rich feed streams and release oxygen to oxygen-deficient feed streams.

“ZPGM Transition Metal Catalyst” refers to at least one catalyst which may include at least one transition metal completely free of platinum group metals.

“Exhaust” refers to discharge of gases, vapor, and fumes created by and released at the end of a process, including hydrocarbons, nitrogen oxide, and carbon monoxide.

“Conversion” refers to the change from harmful compounds (such as hydrocarbons, carbon monoxide, and nitrogen oxide) into less harmful and/or harmless compounds (such as water, carbon dioxide, and nitrogen).

“Correlation” refers to relationship between two variables.

“T50” refers to the temperature at which 50% of a material is converted.

### Description of Drawings

In the following detailed description, reference is made to the accompanying illustrations, which form a part hereof. On these illustrations, which are not to scale or to proportion, similar symbols typically identify similar components, unless context dictates otherwise. The illustrative examples described in the detailed description, are not meant to be limiting. Other examples may be used and other changes may be made without departing from the spirit or scope of the present disclosure.

General Description of Washcoat (WC) and Overcoat (OC)

In the present disclosure, WC generally includes at least one ZPGM transition metal catalyst, such as silver, and carrier material oxides, such as Al₂O₃. Moreover, according to an embodiment of the present disclosure, OC may include ZPGM transition metal catalysts such as copper, rare earth metals such as cerium, and carrier material oxides, but also oxygen storage materials (OSM's). Alternative embodiments may include CeO₂, ZrO₂, and TiO₂, among others, as carrier material oxides. Furthermore, other embodiments of the present disclosure may include other materials. WC or OC materials and ZPGM catalysts may be deposited on a substrate in a single step, employing a co-milling process, or may be synthesized by a suitable chemical technique, such as co-precipitation or any other suitable technique known in the art.

The present disclosure may relate to optimization of ZPGM metal loading of WC and OC, such as silver and copper. Since, the ratio of cerium and copper may be constant, therefore when copper loading is optimized, cerium may be calculated.

The proper combination of these elements may produce uniform coatings, improving quality of catalyst systems, including but not limited to optimization of washcoat adhesion, as well as increasing conversion of hydrocarbon and carbon monoxide.

Preparation of Samples

A ZPGM catalyst system including a ZPGM transition metal catalyst having a metallic substrate, a WC and an OC may be prepared. Metallic substrate may be used with different dimension and cell density (CPSI). WC may include an oxygen storage material (OSM) and support oxide. Additionally, WC may include silver as transition metal. The total amount of silver may be of about 1% by weight to about 20% by weight of the total catalyst weight. OC includes copper oxide, ceria, support oxide, and at least one OSM, which may be a mixture of cerium (Ce), zirconium (Zr), neodymium (Nd), and praseodymium (Pr). The support oxide may include any type of alumina or doped alumina. The OSM and the alumina may be present in WC in a ratio between 40% and about 60% by weight. The alumina and OSM included in OC are present in a ratio of about 60% to about 40% by weight. The copper (Cu) and Ce in OC are present in about 5% to about 50% by weight. The ZPGM catalyst system may be prepared using co-milling, co-precipitation, or other preparation technique known in the art. After deposition, WC and OC may be calcined (fired). This thermal treatment may be performed at about 300° C. to about 700° C. In some embodiments this treatment may be performed at about 550° C. The heat treatment may last from about 2 to about 6 hours. In an embodiment the treatment may last about 4 hours. However, the ramp of heating treatment may vary in some embodiments. The WC and OC loading may vary from 60 g/L to 200 g/L, separately.

Optimization of ZPGM Metal Loading

According to an embodiment of the present disclosure may refer to processes to achieve optimization of Zero-PGM metal loading such as Cu, Ag, and Ce in WC and OC loading. Benefits derived from optimizations, may include increasing conversion of HC and CO and reducing the washcoat adhesion loss.

Extensive testing, experiments, and calculations have been performed for determination of optimum silver and copper loading ratio. The cerium and copper ratio may be considered to be constant, therefore when copper loading change, cerium may be calculated, based on Ce: Cu weight ratio =1.2.

The following examples are intended to illustrate the formulation variations, which may be employed to optimize the scope of the present disclosure. Other procedures known to those skilled in the art may be used alternatively.

In all examples the total loading of washcoat fixed at 100 g/L and the total loading of OC fixed at 80 g/L.

Example #1 may illustrate formulation for maintaining the same silver loading of 4.8 g/L in WC, and variations of copper loadings to 6, 8, and 10 g/L in OC according to Table 1. The influence of such variation on activity and washcoat adhesion lost may be measured.

TABLE 1

| | Ag LOADING | Cu LOADING |
|---|---|---|
| EXAMPLE # | IN WC | IN OC |
| Example # 1 | 4.8 g/L | 6 g/L |
| Example # 1A | 4.8 g/L | 8 g/L |
| Example # 1B | 4.8 g/L | 10 g/L |

Example #2 may illustrate formulation for maintaining the same silver loading of 6.0 g/L in WC, and variations of copper loadings to 6, 8, and 10 g/L in OC according to Table 2. The influence of such variation on activity and washcoat adhesion lost may be measured.

TABLE 2

| | Ag LOADING | Cu LOADING |
|---|---|---|
| EXAMPLE # | IN WC | IN OC |
| Example # 2 | 6.0 g/L | 6 g/L |
| Example # 2A | 6.0 g/L | 8 g/L |
| Example # 2B | 6.0 g/L | 10 g/L |

Example #3 may illustrate formulation for maintaining the same silver loading of 7.2 g/L in WC, and variations of copper loadings to 6, 8, and 10 g/L in OC according to Table 3. The influence of such variation on activity and washcoat adhesion lost may be measured.

TABLE 3

| | Ag LOADING | Cu LOADING |
|---|---|---|
| EXAMPLE # | IN WC | IN OC |
| Example # 3 | 7.2 g/L | 6 g/L |
| Example # 3A | 7.2 g/L | 8 g/L |
| Example # 3B | 7.2 g/L | 10 g/L |

Correlation Between ZPGM Metal Loadings and Catalyst Activity

The catalysts prepared in example #1, example #2, and example #3 are tested under exhaust lean condition with toluene as hydrocarbon feed. The test was performed by increasing the temperature from about 100° C. to about 500° C., at a temperature rate of 40° C. per minute. In case of aged samples, the catalysts are aged at 900° C. for 4 hours under dry air condition. The HC light-off curves and CO light-off curves are used for evaluation of activity variation for different samples. The optimized HC T50 and CO T50 are used to determine the optimum Ag and Cu loadings.

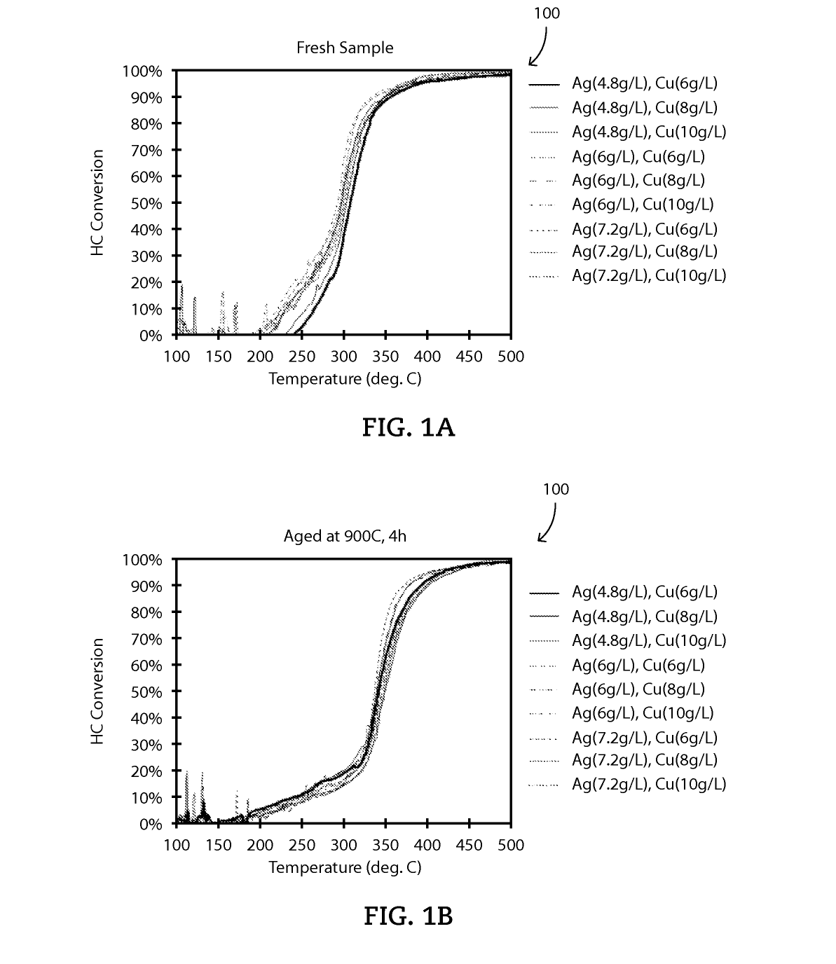

As may be seen in light-off test results 100 in FIG. 1, the graphs for HC conversion, may illustrate different variations of optimized metal loadings of samples prepared in example 1 to 3. The difference between highest and lowest HC T50 for fresh samples is 16 C which corresponds to example #1 and example#2B. The difference between highest and lowest HC T50 for aged samples is 13 C which corresponds to example #1B and example #3. In addition, a regression model may be employed for determination of optimum correlation between metal loadings and HC T50 conversion. The light-off test result 100 for fresh and thermal aged samples can indicate that HC conversion of fresh and aged samples has not been significantly affected by silver and copper loadings.

According to an embodiment, light-off test results 100 may employ a regression model for correlation determination between metal loadings and HC T50. The standard deviation coefficient R2 for fresh HC T50 conversion calculated to be 0.9606, which meant 96.06 percentage of data can be predict by the model, showing good correlation between HC T50 of fresh samples and base metal loading.

The regression models obtained for HC T50 of aged samples may have a R² coefficient of 0.4720, which meant only 47.20% of data can be explained by the model, having very low or no correlation between metal loading and aged HC T50. Therefore aged HC T50 samples have not been significantly affected by variations of copper and silver loading.

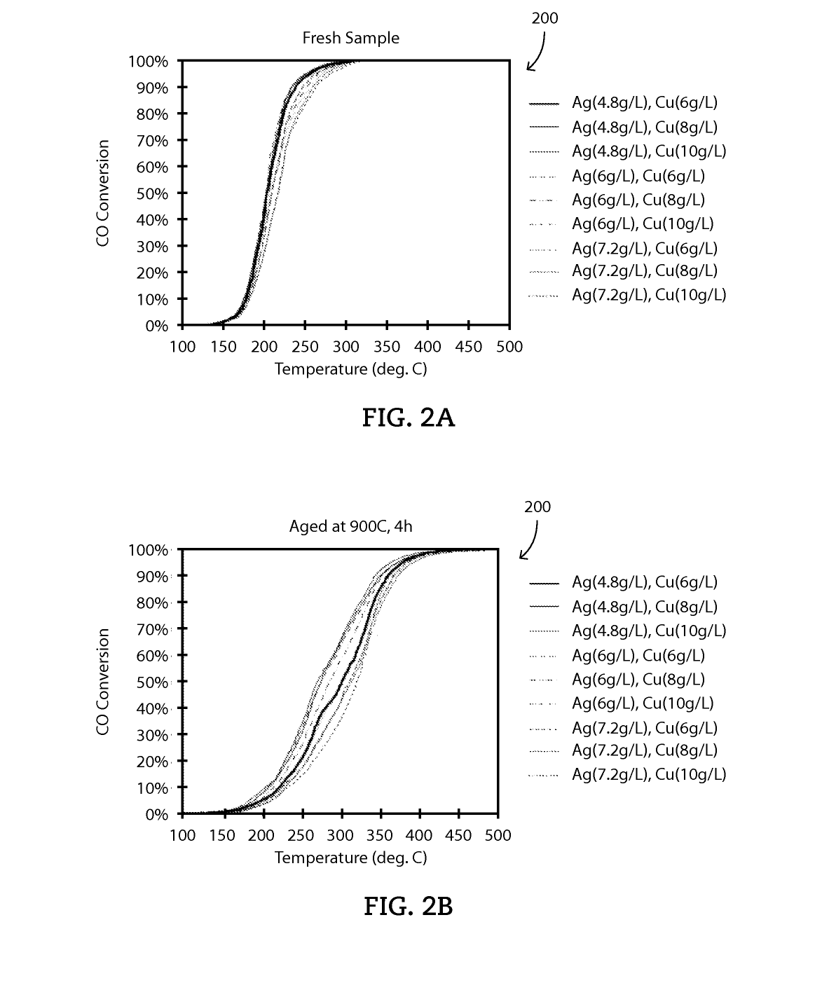

As may be seen in light-off test results 200 in FIG. 2, the graphs for CO conversion, may illustrate different variations of optimized metal loadings of samples prepared in example 1 to 3. The difference between highest and lowest CO T50 for fresh samples is 15C which corresponds to example #2B and example#3A. FIG. 2A may illustrate the light-off test results 200 performed for fresh coated samples that CO light-off of fresh samples has not been significantly affected by base metal loading. The CO light-off test result 200 for aged samples in FIG. 2B may indicate the results obtained from different silver and copper loading combinations, showing that CO light-off of aged samples has been affected by base metal loading, i.e. Cu, Ce and Ag loading. The lowest CO T50 corresponds to example 1A with a T50 of 270 C, however, the highest CO T50 corresponds to example #3 with a CO T50 of 320C. In addition, a regression model may be employed for determination of optimum correlation between metal loadings and CO T50 conversion.

Correlation Between ZPGM Metal Loading and Washcoat Adhesion (WCA) Loss

Table 4, shows test results of WCA loss for variations of Ag and Cu loading in WC and OC, respectively for fresh samples, which can be prepared according to parameters as shown in example #1, example #2 and example #3.

The washcoat adhesion test is performed by quenching the preheated substrate at 550° C. to cold water with angle of 45 degree for 8 seconds followed by re-heating to 150° C. and then blowing cold air at 2,800 L/min. Subsequently, weight loss may be measured to calculate weight loss percentage, which is % WCA loss in present disclosure.

In table 4, may be seen results of WCA loss and variations of fresh samples coated with copper in OC, and its correlation with silver coating in WC. Benefits derived from these experiments, may demonstrate that higher copper loadings may lead to higher washcoat adhesion loss. However, there is no good correlation between WCA loss and loading of silver in WC which means the WCA loss derives by loading of copper in OC.

TABLE 4

| | Cu in OC | | |
|---|---|---|---|
| Ag in WC | 6.0 g/L | 8.0 g/L | 10.0 g/L |
| 4.8 g/L | 0.2 | 3.1 | 10.3 |
| 6.0 g/L | 1.4 | 4.6 | 7.2 |
| 7.2 g/L | 0.9 | 4.3 | 6.7 |

Table 4A shows test results of washcoat adhesion loss for variations of Ag and Cu loading in WC and OC, respectively for aged samples, which can be prepared as shown in example #1, example #2, and example #3.

Aged samples are treated at 900° C. for about 4 hours under dry condition. The results demonstrate that the WCA loss does not affect by aging. Similar to fresh samples, by increasing the copper loading, the WCA loss significantly increase.

TABLE 4A

| | Cu in OC | | |
|---|---|---|---|
| Ag in WC | 6.0 g/L | 8.0 g/L | 10.0 g/L |
| 4.8 g/L | 0.5 | 2.4 | 10.3 |
| 6.0 g/L | 0.5 | 4.6 | 7.2 |
| 7.2 g/L | 0.8 | 4.3 | 6.7 |

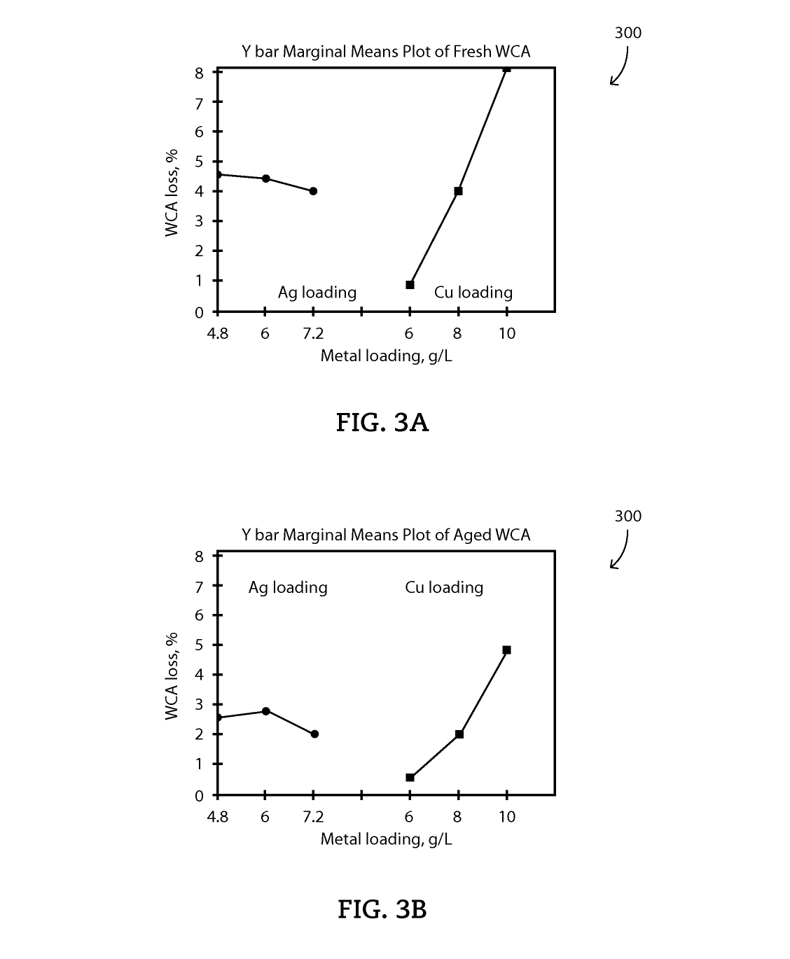

FIG. 3 shows correlation 300 between ZPGM metal loading and WCA based on regression model, in order to optimize the metal loading that leads to minimize washcoat adhesion loss. FIG. 3A for fresh samples, indicates that the variations of silver loadings does not change the WCA loss and the variation of WCA loss percentage is only 0.5% when Ag loading change in the range of 4.8 g/L to 7.2 g/L . However, WCA loss strongly correlates to copper loading. By increasing the copper loading from 6g/L to 10g/L, the washcoat adhesion loss significantly increases from below 1% to around 8%, without having so much dependency on silver loading.

As can be seen in FIG. 3B, aged washcoat adhesion strongly correlate to copper loading. By increasing the copper loading, the WCA loss may significantly increase without having so much dependency on silver loading. In order to keep WCA loss minimized below 3% may require keeping Cu loading below 8 g/L.

Optimum Loading of Silver and Copper in WC and OC

The optimum range of silver loading is obtained based on regression model according to the raw data for HC T50 and CO T50 (as shown in FIG. 1 and FIG. 2), and WCA loss data (as shown in Table 4 and 4A).

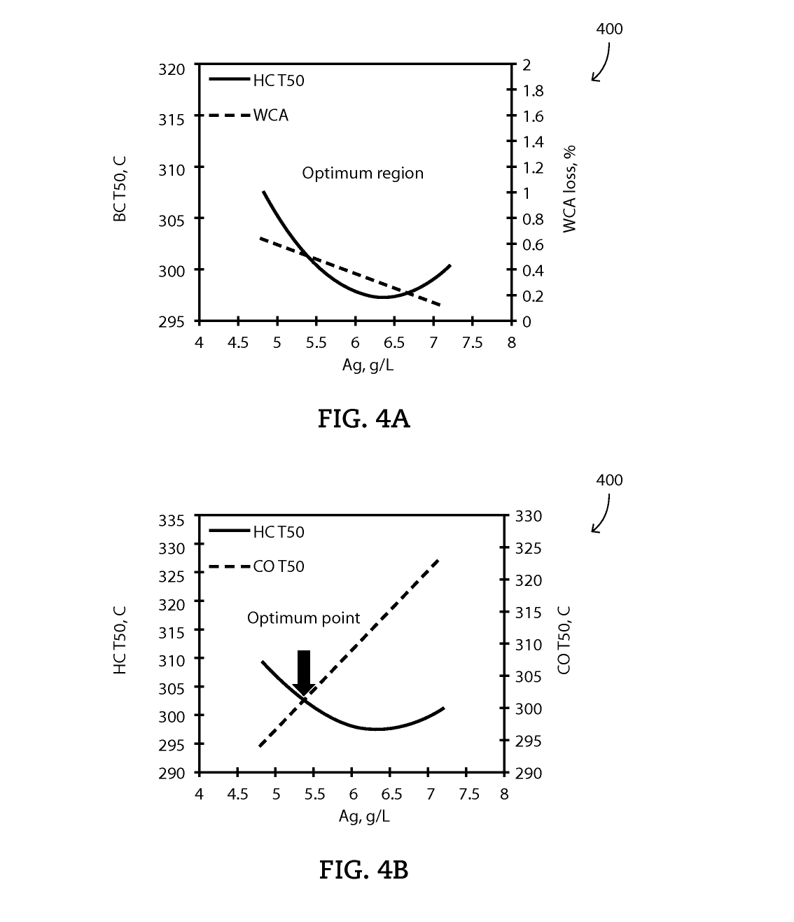

FIG. 4 shows the effect of silver loading on WCA loss and catalyst performance (HC T50 and CO T50) based on prediction models.

As may be seen in FIG. 4A, the optimum point 400 region of silver loading in WC, may be determined by plotting the prediction model for HC T50 of fresh sample and WCA loss of fresh sample. The optimum loading of silver in washcoat may be in the range of 5.5 g/L to 6.5 g/L where both prediction models of HC T50 and WCA loss intersect having lowest HC T50 region.

On the other hand, as may be seen in FIG. 4B, the optimum point 400 of silver loading on WC, may be determined by plotting the prediction model for fresh sample of HC T50 and CO T50. The optimum loading of silver in WC may be at 5.5 g/L where both prediction models of HC T50 and CO T50 intersect.

Based on prediction model, and after experimenting with different silver and copper loadings, has been determined that in order to optimize washcoat adhesion loss and catalyst performance of both HC T50 and CO T50, may require to maintain the optimum loading of silver in WC at about 5.5 g/L.

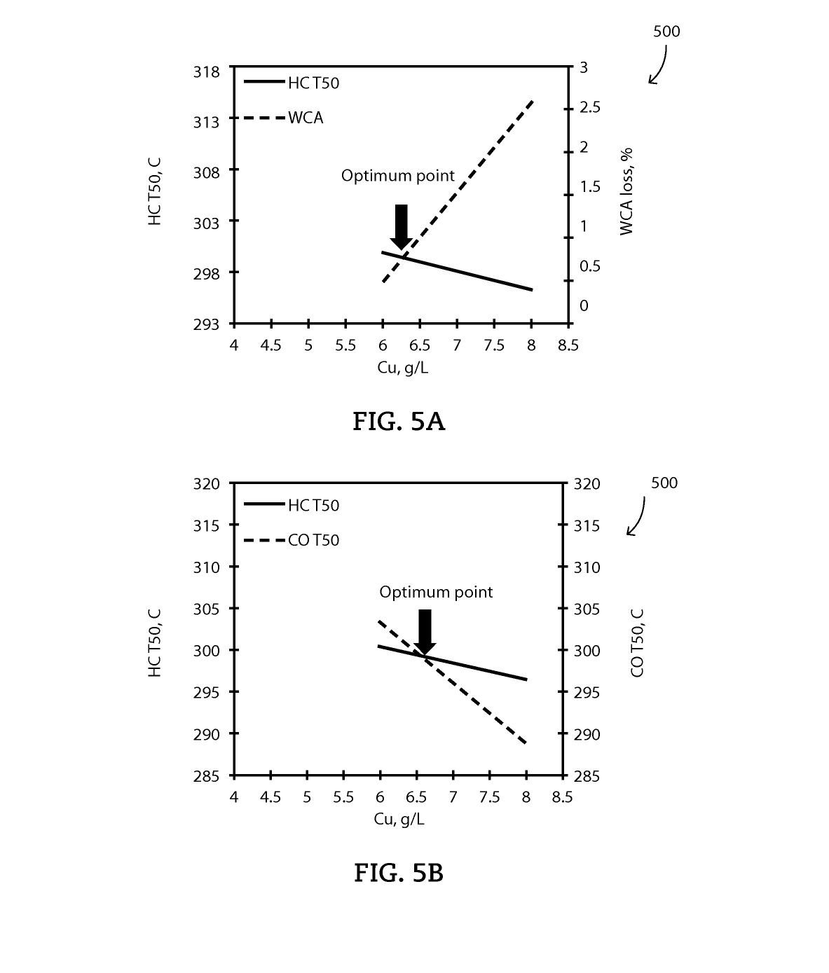

FIG. 5 shows the effect of copper loading on WCA loss and catalyst performance (HC T50 and CO T50) based on prediction models.

As may be seen in FIG. 5A, the optimum point 500 copper loading on OC, may be determined by plotting the prediction model for HC T50 and WCA loss of fresh sample. The optimum loading of copper in OC may be at 6.5 g/L where both prediction models of HC T50 and WCA loss intersect.

On the other hand, as may be seen in FIG. 5B, the optimum point 500 of copper loading in OC, may be determined by plotting the prediction model for HC T50 of fresh sample and CO T50 of fresh sample. The optimum loading of copper in OC may be at 6.5 g/L where both prediction models of HC T50 and CO T50 intersect.

Based on prediction model, and after experimenting with different silver and copper loadings, has been determined that in order to optimize washcoat adhesion loss and catalyst performance of both HC T50 and CO T50, may require to maintain the optimum loading of copper in OC at about 6.5 g/L.

The ratio of cerium and copper may be constant, therefore when copper loading change, cerium may be calculated based on Ce to Cu weight ratio of 1.2. For an optimum copper loading of 6.5 g/L, the optimum cerium loading may be calculated as 7.8 g/L.

Suitable processes may be employed to implement optimization of metal loading on WC and OC. Benefit derived from these optimizations, may enhance removal of main pollutants from exhaust of internal combustion engines, by oxidizing toxic gases with improvement in WCA loss and catalyst performance.

While various aspects of production process may be described in the present disclosure, other aspects, and embodiments may be contemplated. The various aspects and embodiments disclosed here are for purpose of illustration, and are not intended to be limiting with the scope and spirit being indicated by the following claims.

What is claimed is:

1. A method for optimizing a catalytic system, comprising:
providing a catalyst system, comprising:
a substrate;
a washcoat suitable for deposition on the substrate, comprising at least one first oxide solid selected from the group consisting of a first carrier material oxide, at least one first catalyst, and a mixture thereof; and
an overcoat suitable for deposition on the substrate, comprising at least one second oxide solid selected from the group consisting of a second carrier material oxide, at least one second catalyst, and a mixture thereof;
adjusting an amount of metal in the at least one first catalyst whereby the T50 temperatures for HC and CO are substantially equal.

2. The method according to claim 1, wherein the metal is selected from the group consisting of Cu, Ag, Ce, and combinations thereof.

3. The method according to claim 2, wherein the silver in present at about 5.5 g/L.

4. The method according to claim 2, wherein the copper in present at about 6.5 g/L.

5. The method according to claim 4, wherein the ratio of cerium to copper remains substantially unchanged.

6. The method according to claim 2, wherein the copper in present at less than about 8.0 g/L.

7. The method according to claim 1, wherein the substrate is metallic.

8. The method according to claim 1, wherein the overcoat further comprises at least one oxygen storage material.

9. The method according to claim 1, wherein the first carrier material oxide is selected from the group consisting of CeO₂, ZrO₂, TiO₂, and combinations thereof.

10. The method according to claim 1, wherein the second carrier material oxide is selected from the group consisting of CeO₂, ZrO₂, TiO₂, and combinations thereof.

11. A method for optimizing a catalytic system, comprising:
providing a catalyst system, comprising:
a substrate;
a washcoat suitable for deposition on the substrate, comprising at least one first oxide solid selected from the group consisting of a first carrier material oxide, at least one first catalyst, and a mixture thereof; and
an overcoat suitable for deposition on the substrate, comprising at least one second oxide solid selected from the group consisting of a second carrier material oxide, at least one second catalyst, and a mixture thereof;
adjusting an amount of metal in the at least one first catalyst in accordance with the union of the T50 temperature for HC and washcoat adhesion loss.

12. The method according to claim 11, wherein the washcoat adhesion loss is about 0.5%.

13. The method according to claim 11, wherein the washcoat adhesion loss is about 0.5%.

14. The method according to claim 11, wherein the metal is selected from the group consisting of Cu, Ag, Ce, and combinations thereof.

15. The method according to claim 14, wherein the Ag is present at about 4.8 g/L to about 7.2 g/L.

16. The method according to claim 14, wherein the Cu is present at about 6 g/L to about 10 g/L and wherein the washcoat adhesion loss is about 1% to about 8%.

17. The method according to claim 14, wherein the Cu is present at about 6.5 g/L and Ce is present at about 7.8 g/L.
